(19) United States
(12) Patent Application Publication
(10) Pub. No.: US 2005/0259041 A1
(43) Pub. Date: Nov. 24, 2005

(54) Plasma display apparatus and driving method thereof

(76) Inventor: Seong Hak Moon, Seoul (KR)

Correspondence Address: MCKENNA LONG & ALDRIDGE LLP, 1900 K STREET, NW, WASHINGTON, DC, 20006, US

(21) Appl. No.: 11/133,413

(22) Filed: May 20, 2005

(30) Foreign Application Priority Data
May 21, 2004 (KR) 10-2004-0036511
Jul. 19, 2004 (KR) 10-2004-0056124

(51) Int. Cl. G09G 3/28

(52) U.S. Cl. 345/60

(57) ABSTRACT

Provided is a plasma display apparatus. A plasma display apparatus according to a first embodiment of the present invention includes: a plasma display panel (PDP); and a set-up pulse supplying unit generating a constant current to be supplied to the PDP using a set-up voltage source, and supplying a set-up pulse rising to a set-up voltage with a predetermined slope according to a voltage between both terminals of a set-up capacitor charged or discharged by the constant current. A plasma display apparatus according to a second embodiment of the present invention includes: a PDP; a set-up pulse generator including a set-up capacitor for generating a constant current using a set-up voltage source and charging or discharging the constant current, to supply a reset pulse to the PDP; and a set-up pulse outputting unit outputting a set-up pulse rising to a set-up voltage with a predetermined slope according to a voltage between both terminals of the set-up capacitor.

This Nonprovisional application claims priority under 35 U.S.C. § 119(a) on Patent Application No. 10-2004-0036511 filed in Korea on May 21, 2004 and Patent Application No. 10-2004-0056124 filed in Korea on Jul. 19, 2004, the entire contents of which are hereby incorporated by reference.

### BACKGROUND OF THE INVENTION

1. Field of the Invention

The present invention relates to a plasma display apparatus and a driving method thereof.

2. Description of the Background Art

In general, a plasma display panel (PDP) displays images including characters or graphics by exciting phosphors to emit light using 147 nm ultraviolet generated when discharging inert mixture gas, such as He—Xe mixture (He+Xe), Ne—Xe mixture (Ne+Xe) and so on. The PDP can be manufactured to be thin and large and has improved picture quality along with the recent development of PDP techniques. Specifically, in a three-electrode AC surface discharge PDP, since wall charges are accumulated on its surface when discharge occurs and electrodes are protected from sputtering caused by the discharge, low voltage driving and long lifetime are achieved.

FIG. 1 is a perspective view of a conventional three-electode AC surface discharge PDP 100. Referring to FIG. 1, the three-electrode AC surface discharge PDP 100 includes an upper substrate 10 on which scan sustain electrodes 11a (11a for each) and common sustain electrodes 12a (12a for each) are formed and a lower substrate 20 on which address electrodes 22 (22 for each) are formed. The scan electrodes 11a and sustain electrodes 12a, which are transparent electrodes, are made of ITO (Indium-Tin-Oxide). The scan sustain electrodes 11a and common sustain electrodes 12a are respectively mounted together with metal electrodes 11b and 12b for reducing resistance. An upper dielectric layer 13a and a protection film 14 are sequentially applied to the upper substrate 10 on which the scan sustain electrodes 11a and common sustain electrodes 12a are formed. Wall charges created when plasma discharge is carried out are accumulated on the upper dielectric layer 13a. The protection film 14 is used for preventing the upper dielectric layer 13a from being damaged due to sputtering caused by plasma discharge and accelerating secondary electrons. The protection film 14 may be made of MgO.

Meanwhile, a lower dielectric layer 13b and barrier ribs 21 are formed on the lower substrate 20 on which the address electrodes 22 are formed. A phosphor layer 23 is applied to the exposed surface of the lower dielectric layer 13b and the barrier ribs 21. The address electrodes 22 are arranged in a direction intersecting the scan sustain electrodes 11a and common sustain electrodes 12a. The barrier ribs 21 are formed in parallel to the address electrodes 22, so to prevent ultraviolet and visible light generated by discharge from leaking to neighboring discharge cells. The phosphor layer 23 is excited by ultraviolet generated by the plasma discharge, thus emitting one of Red, Green, and Blue colors. Discharge spaces of discharge cells formed between the upper and lower substrates 10 and 20 and the barrier ribs 21 are filled with inert mixture gas, such as He—Xe mixture (He+Xe) or Ne—Xe mixture (Ne+Xe). Now, a driving method of the conventional PDP with the structure described above will be described with reference to FIG. 2.

FIG. 2 is a view for explaining the driving method of the conventional PDP. Referring to FIG. 2, the PDP driving method divides a subfield into an initialization period for initializing the entire screen of the PDP, an address period for selecting cells, and a sustain period for maintaining discharging of the selected cells. In the initialization period (reset period), a reset pulse is applied to all scan electrodes Y, wherein the reset pulse consists of a ramp-up pulse Ramp-up, a flat pulse Flat, and a ramp-down pulse Ramp-down. In the set-up period SU of the reset period, the ramp-up pulse Ramp-up is applied simultaneously to all the scan electrodes Y. By applying the ramp-up pulse Ramp-up, discharge is generated in all cells of a screen. Due to this set-up discharge, positive wall charges are accumulated on address electrodes X and sustain electrodes Z and negative wall charges are accumulated on the scan electrodes Y.

In the set-down period SD after the ramp-up pulse Ramp-up is applied, the ramp-down pulse Ramp-down is applied, falling from a positive voltage lower than the peak voltage of the ramp-up pulse Ramp-up to a ground voltage or to a predetermined negative voltage, so to generate weak erase discharge in the cells and thus partially erase unnecessary wall charges. Due to this set-down discharge, sufficient wall charges to stably generate address discharge uniformly remain in each of the cells.

Successively, in the address period, a negative scan pulse Scan is sequentially applied to the scan electrodes Y and simultaneously a positive data pulse data is applied to the address electrodes X in synchronization with the scan pulse Scan. A potential difference between the scan pulse Scan and data pulse data is added with a wall voltage created during the initialization period, so to generate address discharge in cells to which the data pulse data is applied. When a sustain voltage is applied to the cells selected by the address discharge, sufficient wall charges to generate discharge are formed. In the set-down period SD and the address period, a positive DC voltage Zdc is applied to the sustain electrodes Z, so to reduce a voltage difference between the sustain electrodes Z and the scan electrodes Y and thus prevent wrong discharge between the sustain electrodes Z and the scan electrodes Y.

In the sustain period, a sustain pulse Sus is alternately applied to the scan electrodes Y and the sustain electrodes Z. In the cells selected by the address discharge, sustain discharge, that is, display discharge is generated between the scan electrodes Y and the sustain electrodes Z whenever the sustain pulse Sus is applied to be added with the wall voltage in the cells.

After the sustain discharge is performed, a ramp waveform with short pulse width and low voltage is supplied to the sustain electrodes Z, so to erase all wall charges remaining in the cells of the screen.

A scan electrode driving apparatus for supplying a predetermined driving waveform to the conventional PDP which is driven by the PDP driving method described above, is shown in FIG. 3.

FIG. 3 is a circuit diagram of the scan electrode driving apparatus of the conventional PDP. Referring to FIG. 3, the scan electrode driving apparatus includes a sustain pulse supplying unit 40, a set-up pulse supplying unit 42, a set-down pulse supplying unit 44, a negative scan voltage supplying unit 46, a drive integrated circuit 48, a scan reference voltage supplying unit 50, and a seventh switch Q7 connected between the set-up supplying unit 42 and the drive integrated circuit 48.

The scan electrode driving apparatus with the structure described above generates a rising ramp waveform and a falling ramp waveform in a reset period. At this time, the operations of respective switches will be described with reference to FIG. 4.

FIG. 4 is a timing diagram illustrating a switching operation of the conventional scan electrode driving apparatus for generating a rising ramp waveform and a falling ramp waveform in a reset period, as shown in FIG. 3. Before explaining a process for generating set-up and set-down voltages in the reset period, it is assumed that the voltage Vₛₜ of a set-up voltage source is discharged in a second capacitor C2 of FIG. 3. Also, it is assumed that a sustain voltage Vₛ is supplied from the sustain pulse supplying unit 40 to a node n1 when a fifth switch Q5 being a set-up switch is turned on.

Referring to FIG. 4, in a set-up period, the fifth switch Q5 and the seventh switch Q7 are turned on. At this time, the sustain voltage Vₛ is supplied from the sustain pulse supplying unit 40. The sustain voltage Vₛ supplied from the sustain pulse supplying unit 40 is applied to scan electrode lines Y1 through Ym via an internal diode of a sixth switch Q6, the seventh switch Q7, and the drive integrated circuit 48. Accordingly, the voltage of the scan electrode lines Y1 through Ym sharply rises to Vₛ.

At this time, since the voltage Vₛ is supplied to the negative terminal of the second capacitor C2, the second capacitor C2 supplies a voltage of Vₛ+Vₛₜ to the fifth switch Q5. The fifth switch Q5 supplies a voltage supplied from the second capacitor C2, whose channel width is controlled by a first variable resistor VR1 before the first switch Q5, to the first node n1 with a predetermined slope. The voltage with the predetermined slope applied to the first node n1 is supplied to the scan electrode lines Y1 through Ym via the seventh switch Q7 and the drive integrated circuit 48. That is, a rising ramp waveform Ramp-up is applied to the scan electrode lines Y1 through Ym.

After the rising ramp waveform is supplied to the scan electrode lines Y1 through Ym, the fifth switch Q5 is turned off. Thus, the voltage Vₛ supplied from the sustain pulse supplying unit 40 is applied to the first node n1 and accordingly the voltage of the scan electrode lines Y1 through Ym sharply falls to Vₛ.

Thereafter, in the set-down period, the seventh switch Q7 is turned off and a tenth switch Q10 is turned on. The tenth switch Q10 falls a voltage of the second node n2, whose channel width is controlled by a second variable resistor VR2 before the tenth switch Q10, to a scan voltage −V_{w} (or set-down voltage) with a predetermined slope. That is, a falling ramp waveform Ramp-down is supplied to the scan electrode lines Y1 through Ym.

The set-up pulse supplying unit 42 and the set-down pulse supplying unit 44 supply a rising ramp waveform and a falling ramp waveform to the scan electrode lines Y1 through Ym, by repeating the process described above.

Meanwhile, since the high voltage of Vₛ+Vₛₜ is gradually supplied to the fifth switch Q5 as a set-up switch during a long time in order to supply the rising ramp waveform Ramp-up, heat is generated due to resistance. The heat is generated since the fifth switch Q5 operates in an active region during which the ramp waveform rise.

Conventionally, in order to eliminate the generation of heat, a high-cost switching device with enhanced withstanding voltage characteristic has been used, which increases the manufacturing cost of a PDP.

Further, due to the generation of heat in the fifth switch Q5, the slope or characteristics of the ramp-up pulse Ramp-up may vary unintendedly.

### SUMMARY OF THE INVENTION

Accordingly, an object of the present invention is to solve at least the problems and disadvantages of the background art.

The present invention provides a plasma display apparatus, capable of eliminating the generation of heat and reducing a manufacturing cost, by varying the circuit of a switching device operating in a reset period of a plasma display panel (PDP).

According to an aspect of the present invention, there is provided a plasma display apparatus including: a plasma display panel (PDP); and a set-up pulse supplying unit generating a constant current to be supplied to the PDP using a set-up voltage source, and supplying a set-up pulse rising to a set-up voltage with a predetermined slope according to a voltage between both terminals of a set-up capacitor charged or discharged by the constant current.

According to another aspect of the present invention, there is provided a plasma display apparatus including: a PDP; a set-up pulse generator including a set-up capacitor for generating a constant current using a set-up voltage source and charging or discharging the constant current, to supply a reset pulse to the PDP; and a set-up pulse outputting unit outputting a set-up pulse rising to a set-up voltage with a predetermined slope according to a voltage between both terminals of the set-up capacitor.

Therefore, it is possible to prevent the generation of heat in a switching device due to a rising ramp waveform supplied to a PDP and reduce manufacturing cost through usage of low-cost switches.

### BRIEF DESCRIPTION OF THE DRAWINGS

The invention will be described in detail with reference to the following drawings in which like numerals refer to like elements.

FIG. 1 is a perspective view of a conventional three-electrode AC surface discharge plasma display panel (PDP);

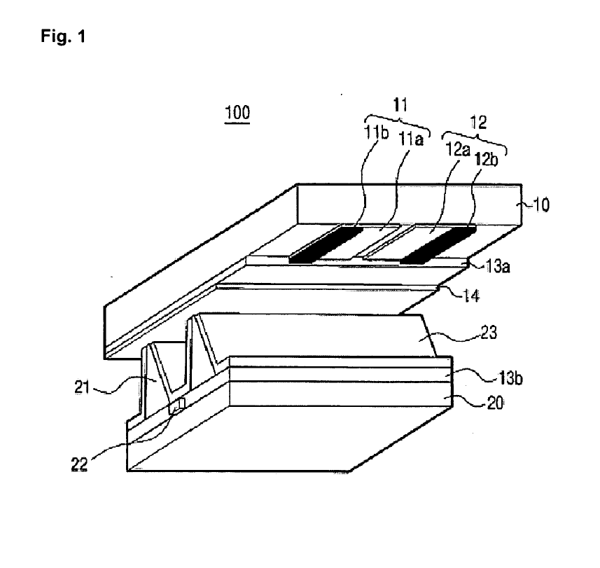

FIG. 2 is a view for explaining a driving method of the conventional PDP;

FIG. 3 is a circuit diagram of a scan electrode driving apparatus of the conventional PDP;

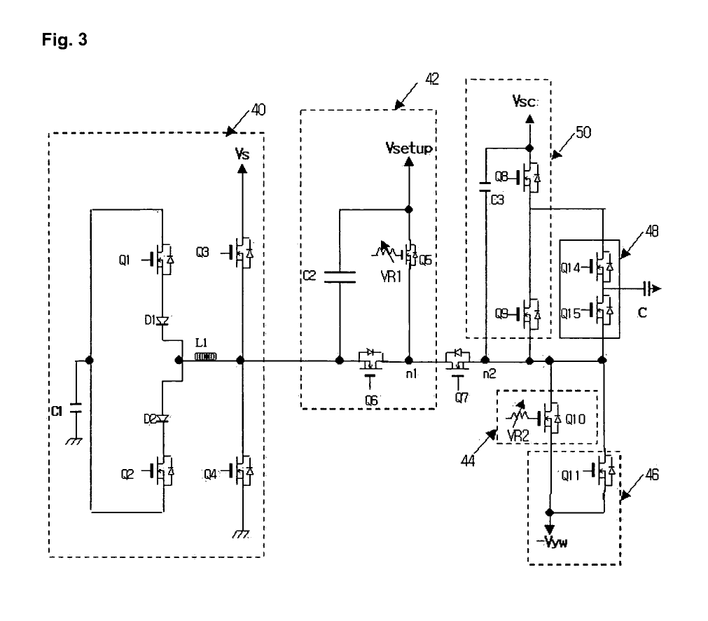

FIG. 4 is a timing diagram illustrating a switching operation of the conventional scan electrode driving apparatus for generating a rising ramp waveform and a falling ramp waveform in a reset period, as shown in FIG. 3;

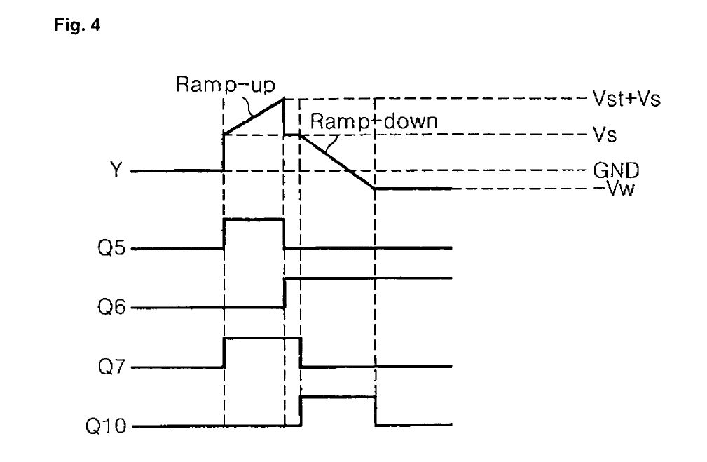

FIG. 5 is a block diagram of a plasma display apparatus according to a first embodiment of the present invention;

FIG. 6 is a circuit diagram of a scan electrode driver of the plasma display apparatus according to the first embodiment of the present invention; and

FIG. 7 is a circuit diagram of a scan electrode driver of a plasma display apparatus according to a second embodiment of the present invention.

### DETAILED DESCRIPTION OF PREFERRED EMBODIMENTS

Preferred embodiments of the present invention will be described in a more detailed manner with reference to the drawings.

### First Embodiment

A plasma display apparatus according to a first embodiment of the present invention includes: a plasma display panel (PDP); and a set-up pulse supplying unit generating a constant current to be supplied to the PDP using a set-up voltage source, and supplying a set-up pulse rising to a set-up voltage with a predetermined slope according to a voltage between both terminals of a set-up capacitor charged or discharged by the constant current.

The set-up voltage source includes a set-up switch.

The set-up pulse supplying unit includes a variable resistor for controlling the slope of the voltage between both terminals of the set-up capacitor.

The variable resistor is connected between the set-up capacitor and the set-up voltage source.

The constant current is generated by the set-up switch that operates in a saturation region.

Hereinafter, the plasma display apparatus according to the first embodiment of the present invention will be described in detail with reference to the appended drawings.

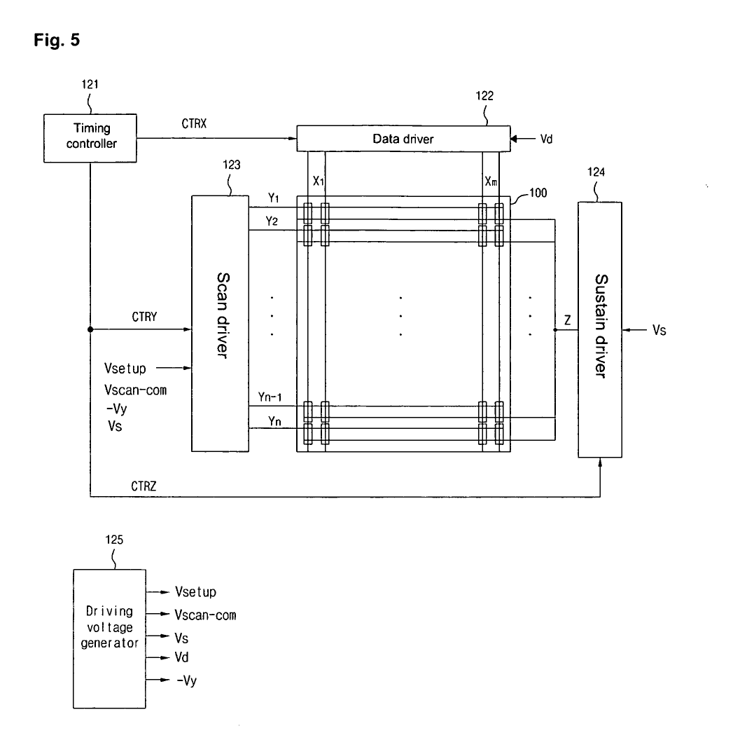

FIG. 5 is a block diagram of the plasma display apparatus according to the first embodiment of the present invention.

As shown in FIG. 5, the plasma display apparatus includes: a PDP 100; a data driver 122 for supplying data to address electrodes X1 through Xm formed on a lower substrate (not shown) of the PDP 100; a scan driver 123 for driving scan electrodes Y1 through Yn; a sustain driver 124 for driving sustain electrodes Z as common electrodes; a timing controller 121 for controlling the data driver 122, the scan driver 123, and the sustain driver 124 when the PDP 100 is driven; and a driving voltage generator 125 for supplying a driving voltage required for the data driver 122, the scan driver 123, and the sustain driver 124.

In the PDP 100, an upper substrate (not shown) is coupled, separated by a predetermined distance, with the lower substrate (not shown). A plurality of electrodes, for example, the scan electrodes Y1 through Yn and the sustain electrodes Z are formed in pair on the upper substrate. The address electrodes X1 through Xm are formed on the lower substrate in a manner to interest the scan electrodes Y1 through Yn and the sustain electrodes Z.

Data, which are subjected to inverse-gamma correction and error diffusion by an inverse-gamma correction circuit (not shown), an error diffusion circuit (not shown) and so on and mapped to respective subfields by a subfield mapping circuit (not shown), are supplied to the data driver 122. The data driver 122 samples and latches the data in response to a timing control signal CTRL from the timing controller 121 and then supplies the resultant data to the address electrodes X1 through Xm.

The scan driver 123 supplies a rising ramp waveform Ramp-up and a falling ramp waveform Ramp-down to the scan electrodes Y1 through Yn in a reset period under the control of the timing controller 121. Also, the scan driver 123 sequentially supplies a scan pulse Sₚ of a scan voltage −V_{y} to the scan electrodes Y1 through Yn in an address period and supplies a sustain pulse generated by an energy collecting circuit included therein to the scan electrodes Y1 through Yn in a sustain period, under the control of the timing controller 121.

The sustain driver 124 supplies a bias voltage of a sustain voltage Vₛ to the sustain electrodes Z in a period during which a falling ramp waveform Ramp-down is generated and in an address period. A sustain driving circuit included in the scan driver 123 operates alternately with a sustain driving circuit included in the scan driver 123 to supply a sustain pulse Sus to the sustain electrodes Z in the sustain period, under the control of the timing controller 121.

The timing controller 121 receives a horizontal/vertical synchronization signal and a clock signal, generates timing control signals CTRX, CTRY, and CTRZ for controlling the operation timing and synchronization of the respective drivers 122, 123, and 124 in the reset period, address period, and sustain period, and supplies the timing control signals CTRX, CTRY, and CTRZ to the corresponding drivers 122, 123, and 124 to thus control the drivers 122, 123, and 124.

Meanwhile, the timing control signal CTRX as a data control signal includes a sampling clock for sampling data, a latch control signal, and a switch control signal for controlling the on/off time of the sustain driving circuit and a driving switch device. The timing control signal CTRY as a scan control signal includes a switch control signal for controlling the on/off time of the driving switch device and the sustain driving circuit included in the scan driver 123. The timing control signal CTRZ as a sustain control signal includes a switch control signal for controlling the on/off time of the driving switch device and the sustain driving circuit included in the sustain driver 124.

The driving voltage generator 125 generates a set-up voltage Vₛₑₜ, a scan common voltage V_{scan-com}, a scan voltage −V_{y}, the sustain voltage Vₛ, a data voltage V_{d} and so on. The driving voltages can vary according to the composition of discharge gas or the structure of discharge cells.

The plasma display apparatus according to the first embodiment of the present invention, with the structure described above, displays an image consisting of frames using the combination of at least one subfield in which a driving pulse is applied to the address electrodes, the scan electrodes, and the sustain electrodes in a reset period, address period, and sustain period.

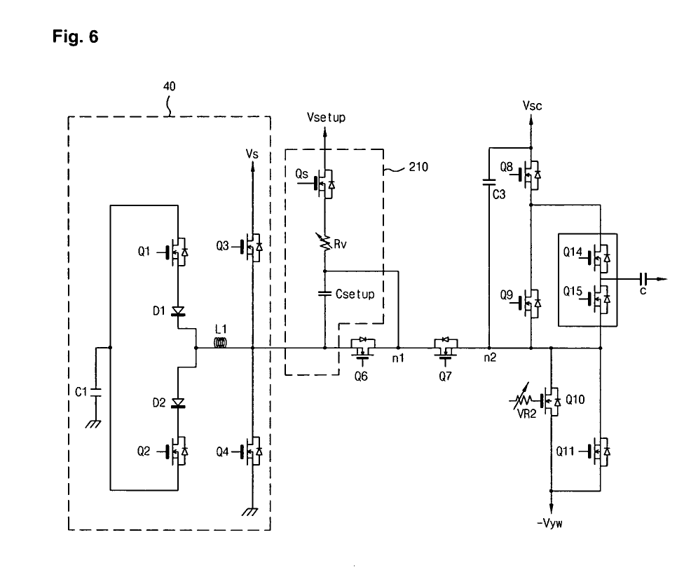

Meanwhile, a scan driver, which operates in a reset period when the plasma display apparatus according to the first embodiment of the present invention is driven, is shown in FIG. 6.

FIG. 6 is a circuit diagram of the scan driver of the plasma display apparatus according to the first embodiment of the present invention. Referring to FIG. 6, the scan driver includes a set-up pulse supplying unit 210 for supplying a reset pulse to the scan electrodes in a set-up period SU.

The set-up pulse supplying unit 210 includes a set-up switch Qₛ, a variable resistor Rᵥ, and a set-up capacitor Cₛₑₜᵤₚ.

The drain terminal of the set-up switch Qₛ is connected to a set-up voltage source Vₛₑₜᵤₚ. One end of the variable resistor Rᵥ is connected to the source terminal of the set-up switch Qₛ. One end of the set-up capacitor Cₛₑₜᵤₚ is connected to the other end of the variable resistor Rᵥ.

The set-up switch Qₛ is turned on in response to a timing signal and operates in a saturation region. Thus, the set-up voltage source Vₛₑₜᵤₚ and the set-up switch Qₛ function as a constant current source. Accordingly, heat generated in the set-up switch Qₛ is very small compared to a conventional set-up switch Q5 that operates in an active period. As such, since heat generated in the set-up switch Qₛ is very small, a problem that the slope or characteristics of a ramp-up pulse varies unintendedly can be solved.

The slope of a ramp-up pulse is decided by the variable resistor Rᵥ and the set-up capacitor Cₛₑₜᵤₚ. That is, a constant current flows to the set-up capacitor Cₛₑₜᵤₚ via the variable resistor Rᵥ by the set-up voltage source Vₛₑₜᵤₚ and the set-up switch Qₛ that operates in a saturation region, thereby charging the set-up capacitor Cₛₑₜᵤₚ.

As such, when the set-up capacitor Cₛₑₜᵤₚ is charged, a voltage between both terminals of the set-up capacitor Cₛₑₜᵤₚ generates a ramp-up pulse rising to the set-up voltage Vₛₑₜᵤₚ with a predetermined slope and the ramp-up pulse is applied to the scan electrodes.

If the resistance of the variable resistor Rᵥ varies, the time constants of the variable resistor Rᵥ and the set-up capacitor Cₛₑₜᵤₚ vary and, thus, a speed at which the set-up capacitor Cₛₑₜᵤₚ is charged changes, so that the slope of the ramp-up pulse can be controlled.

In the set-down period SD, since the potential of the scan electrodes should fall from the set-up voltage Vₛₑₜᵤₚ, the second switch Q2 is turned on to discharge the set-up capacitor Cₛₑₜᵤₚ.

As described above, the plasma display apparatus according to the first embodiment of the present invention does not generate any heat since the set-up switch Qₛ included in the set-up pulse supplying unit 210 operates in the saturation region of the set-up period, instead of the active period. Accordingly, set-up switches for low-current can be used under the same voltage, resulting in reducing manufacturing cost.

### Second Embodiment

A plasma display apparatus according to a second embodiment of the present invention includes: a PDP; a set-up pulse generator including a set-up capacitor for generating a constant current using a set-up voltage source and charging or discharging the constant current, to supply a reset pulse to the PDP; and a set-up pulse outputting unit outputting a set-up pulse rising to a set-up voltage with a predetermined slope according to a voltage between both terminals of the set-up capacitor.

The constant current is generated by a set-up switch that operates in a saturation region.

The set-up switch is connected to the set-up voltage source.

The set-up pulse generator includes a variable resistor for controlling the slope of the voltage between both terminals of the set-up capacitor.

The variable resistor is connected between the set-up switch and the set-up capacitor.

The set-up pulse generator further includes a timing switch for discharging charges charged in the set-up capacitor.

The timing switch is connected in parallel to the set-up capacitor.

The set-up pulse outputting unit includes a first operation switch and a second operation switch. The first and second operation switches perform push-pull operations according to the voltage between both terminals of the set-up capacitor.

The plat pulse width of the set-up pulse is controlled according to the pulse width of a timing signal for controlling the operation of the timing switch.

Hereinafter, a plasma display apparatus according to a second embodiment of the present invention will be described in detail with reference to an appended drawing.

### Second Embodiment

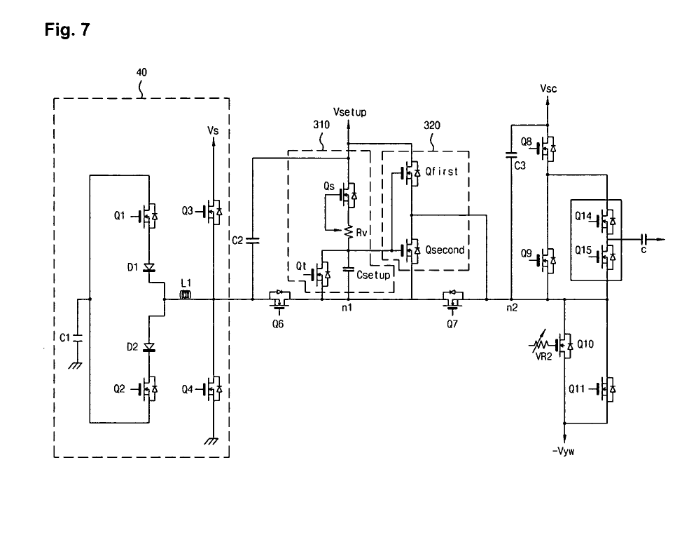

FIG. 7 is a circuit diagram of a scan electrode driver of a plasma display apparatus according to a second embodiment of the present invention. In the plasma display apparatus according to the second embodiment of the present invention, the remaining portion excluding a driving circuit of a scan driver has the same structure as a corresponding portion of the plasma display apparatus according to the first embodiment of the present invention, and therefore a detailed description thereof is omitted.

As described above, the scan driver of the plasma display apparatus according to the second embodiment of the present invention includes a set-up pulse generator 310 and a set-up pulse outputting unit 320 for supplying a set-up pulse to scan electrodes in a set-up period SU.

The set-up pulse generator 310 includes a set-up switch Qₛ, a variable resistor Rᵥ, a set-up capacitor Cₛₑₜᵤₚ, and a timing switch Qₜ.

The drain terminal of the set-up switch Qₛ is connected to a set-up voltage source Vₛₑₜᵤₚ. One end of the variable resistor Rᵥ is connected to the source terminal of the set-up switch Qₛ. One end of the set-up capacitor Cₛₑₜᵤₚ is connected to the other end of the variable resistor Rᵥ. The drain terminal of the timing switch Qₜ is connected to the end of the set-up capacitor Cₛₑₜᵤₚ and the source terminal of the timing switch Qₜ is connected to the other end of the set-up capacitor Cₛₑₜᵤₚ.

The set-up pulse outputting unit 320 includes a first operation switch Q_{first} and a second operation switch Q_{second}.

The drain terminal of the first operation switch Q_{first} is connected to the set-up voltage source Vₛₑₜᵤₚ. The drain terminal of the second operation switch Q_{second} is connected to the source terminal of the first operation switch Q_{first}. The gate terminals of the first and second operation switches Q_{first} and Q_{second} are connected to each other and connected to one end of the set-up capacitor Cₛₑₜᵤₚ.

The conventional set-up switch Q5 is set to operate in an active period, however, the set-up switch Qₛ of the present invention is set to operate in a saturation region.

Since the set-up switch Qₛ of the present invention operates in the saturation region, the set-up voltage source Vₛₑₜᵤₚ and the set up switch Qₛ function as a constant current source. Accordingly, heat generated in the set-up switch Qₛ is very small compared to that generated in the conventional set-up switch Q5 that operates in the active period. As such, since heat generated in the set-up switch Qₛ is small, a problem that the slope or characteristics of the ramp-up pulse varies unintendedly, can be solved.

The slope of a ramp-up pulse is decided by the variable resistor Rᵥ and the set-up capacitor Cₛₑₜᵤₚ. That is, a constant current flows to the set-up capacitor Cₛₑₜᵤₚ via the variable resistor Rᵥ by the set-up voltage source Vₛₑₜᵤₚ and the set-up switch Qₛ that operates in the saturation region, so to charge the set-up capacitor Cₛₑₜᵤₚ.

As such, when the set-up capacitor Cₛₑₜᵤₚ is charged, a voltage between both terminals of the set-up capacitor Cₛₑₜᵤₚ gradually rises with a predetermined slope. Thus, the first operation switch Q_{first} is gradually turned on and applies a ramp-up pulse with a predetermined slope rising to the set-up voltage Vₛₑₜᵤₚ to the scan electrodes.

If the resistance of the variable resistor Rᵥ varies, the time constants of the variable resistor Rᵥ and the set-up capacitor Cₛₑₜᵤₚ vary and, thus, a speed at which the set-up capacitor Cₛₑₜᵤₚ is charged changes, so that the slope of the ramp-up pulse can be controlled.

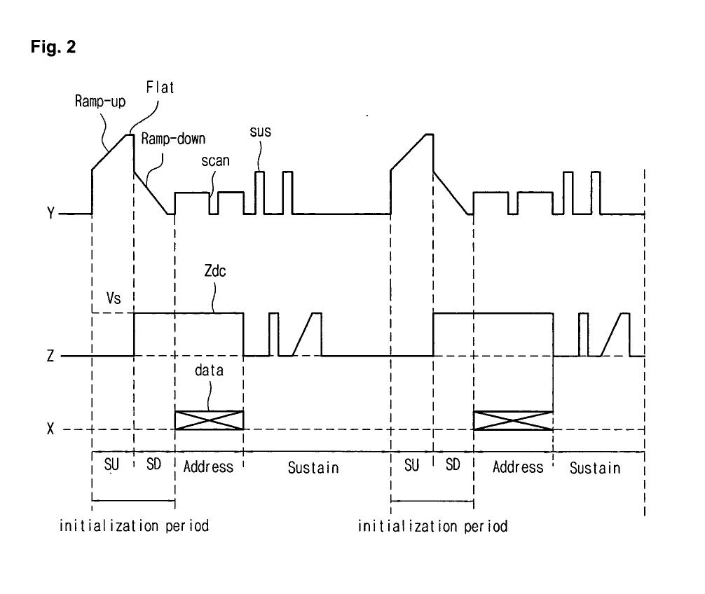

In the set-down period SD, since the potential of the scan electrodes should fall at the set-up voltage Vₛₑₜᵤₚ, the timing switch Qₜ and the second switch Q_{second} are turned on, so to discharge the set-up capacitor Cₛₑₜᵤₚ. Here, the pulse width of the flat pulse Flat shown in FIG. 2 is decided according to the pulse width of a timing signal for controlling the turn-on/turn-off operation of the timing switch Qₜ.

That is, if the turn-off time of the timing switch Qₜ increases, a voltage between both terminals of the set-up capacitor Cₛₑₜᵤₚ rises with a predetermined slope and is maintained constant at a predetermined time.

Accordingly, a voltage of the scan electrodes rises with a predetermined slope and is maintained at the set-up voltage Vₛₑₜᵤₚ, according to the turn-on operation of the first operation switch Q_{first}. Thereafter, if the timing switch Qₜ is turned on, the set-up capacitor Cₛₑₜᵤₚ is discharged, thus terminating the flat pulse Flat.

Since the pulse width of the flat pulse Flat is decided according to the turn-off time of the timing switch Qₜ, the pulse width of the flat pulse Flat depends on the pulse width of the timing signal for deciding the turn-off time of the timing switch Qₜ.

As such, by controlling the slope of a ramp-up pulse and the pulse width of a flat pulse, it is possible to maximize the discharge characteristics.

The first and second operation switches Q_{first} and Q_{second} which output a reset pulse constitute a push-pull circuit.

The first and second operation switches Q_{first} and Q_{second} constituting the push-pull circuit prevent a sustain pulse of a high-frequency high voltage output by a sustainer 40 from affecting a reset pulse.

That is, since the push-pull circuit composed of the first and second operation switches Q_{first} and Q_{second} has high input impedance and low output impedance, the push-pull circuit is isolated from the sustainer 40 and is less influenced by the sustain pulse of the high-frequency high voltage.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
a plasma display panel (PDP); and
a set-up pulse supplying unit generating a constant current using a set-up voltage source, and supplying a set-up pulse which rises to a set-up voltage with a predetermined slope according to a voltage of a set-up capacitor which is charged or discharged by the constant current.

2. The plasma display apparatus of claim 1, wherein the set-up voltage source includes a set-up switch.

3. The plasma display apparatus of claim 1, wherein the set-up pulse supplying unit includes a variable resistor for controlling the slope of the voltage of the set-up capacitor.

4. The plasma display apparatus of claim 3, wherein the variable resistor is connected between the set-up capacitor and the set-up voltage source.

5. The plasma display apparatus of claim 1, wherein the constant current is generated by a set-up switch that operates in a saturation region.

6. A plasma display apparatus comprising:
a plasma display panel (PDP);
a set-up pulse generator including a set-up capacitor for generating a constant current using a set-up voltage source and charging or discharging the constant current, in order to supply a reset pulse to the PDP; and
a set-up pulse output unit outputting a set-up pulse which rises to a set-up voltage with a predetermined slope according to a voltage of the set-up capacitor.

7. The plasma display apparatus of claim 6, wherein the constant current is generated by a set-up switch that operates in a saturation region.

8. The plasma display apparatus of claim 7, wherein the set-up switch is connected to the set-up voltage source.

9. The plasma display apparatus of claim 6, wherein the set-up pulse generator includes a variable resistor for controlling the slope of a voltage of the set-up capacitor.

10. The plasma display apparatus of claim 9, wherein the variable resistor is connected between the set-up switch and the set-up capacitor.

11. The plasma display apparatus of claim 6, wherein the set-up pulse generator further comprises a timing switch for discharging charges charged in the set-up capacitor.

12. The plasma display apparatus of claim 11, wherein the timing switch is connected in parallel with the set-up capacitor.

13. The plasma display apparatus of claim 6, wherein the set-up pulse output unit includes a first operation switch and a second operation switch, and wherein the first operation switch and the second operation switch perform a push-pull operation according to the voltage of the set-up capacitor.

14. The plasma display apparatus of claim 11, wherein the pulse width of a flat pulse in the set-up pulse is controlled according to the pulse width of a timing signal for controlling the operation of the timing switch.
